(19) United States
(12) Patent Application Publication
(10) Pub. No.: US 2002/0046128 A1
(43) Pub. Date: Apr. 18, 2002

(54) Automatic pricing method and device

(75) Inventors: Naoki Abe, Tokyo (JP); Tomonari Kamba, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/853,692

(22) Filed: May 14, 2001

(30) Foreign Application Priority Data
Sep. 7, 2000 (JP) 2000-271760

(51) Int. Cl. G06F 17/60; G06G 7/00; G06F 17/00

(52) U.S. Cl. 705/26; 705/400

(57) ABSTRACT

A system automatically sets the prices of items that are marketed in a web marketing system based on such factors as past prices and marketing trends so as to maximize the seller's profit. An automatic price calculating unit is provided that refers to item information and marketing information that are gathered from the web marketing system, updates the prices of items, and outputs the result as price information. At each point in time, the calculating unit repeats the steps of: outputting price information such that items are marketed for fixed time intervals at a price that is one step size higher than, and a price that is one step size lower than the optimal price estimate at that time, comparing the profits that are obtained as a result, and updating the optimal price estimate at that time in the direction of the price at which the higher profit was obtained.

### BACKGROUND OF THE INVENTION

1. Field of the Invention

The present invention relates to an electronic commerce system that employs a network such as the Internet, and particularly to a method and a device for pricing items that are marketed or for determining items to be displayed in the web marketing system when conducting electronic commerce using a web marketing system on a network.

2. Description of the Related Art

With the popularization of networks such as the Internet, servers referred to as “web marketing systems” have been established as electronic commerce systems on these networks, and the online offering of services and sales of goods has gained widespread acceptance. The price of sales items in these electronic commerce systems is generally fixed at a value determined by the system manager. There are also examples known as “auction systems” and “reverse auction systems” that employ dynamic pricing.

However, no electronic commerce system exists in which sales prices are automatically set using past sales records with the aim of maximizing the seller's profits.

The electronic commerce system that can be considered to be the most relevant to the present invention is used at a web marketing site called “outletzoo.com” (http://outletzoo.com/) and adopts a dynamic pricing method in which prices drop at a fixed rate with the object of selling all surplus stock. Since prices change according to a fixed schedule in this method, however, this method lacks the function of setting optimal price according to the history of past sales.

From the viewpoint of the capacity of the server, a single electronic commerce system or web marketing system is considered capable of handling from several tens of thousands to several hundreds of thousands of items. Customers that visit these systems generally browse the system web page and decide on items to purchase using Internet browser software. Although optimal display of items on the web page is considered necessary to maximize the total sales or total profit, electronic commerce systems or web marketing systems of the prior art lacked the viewpoint of optimizing the determination of items that are displayed.

### SUMMARY OF THE INVENTION

It is an object of the present invention to provide a method and device that were lacking in electronic commerce systems of the prior art for setting the price of an item to be sold based on such factors as past prices and sales trends so as to automatically maximize the profit of the seller.

It is another object of the present invention to provide a method and device for determining items that should be displayed so as to automatically maximize the profits of a seller in an electronic commerce system.

The object of the present invention is an automatic pricing method for setting the prices of items that are marketed in a web marketing system that performs electronic commerce on a network, and includes steps of: at each point in time, carrying out marketing for fixed time intervals using a price that is one step size higher than, and a price that is the same step size lower than, the optimal price estimate at that time; comparing profits obtained as the result of the marketing; updating the optimal price estimate at the time in question in a direction of price at which greater profit was obtained; and repeating the marketing step, the comparison step, and the updating step.

The object of the present invention is also achieved by an automatic pricing method which comprises the steps of: (i) calculating, at each point in time, a price for each item by using both a weight vector obtained by adding a step vector that is generated randomly or pseudo-randomly to the estimate of the optimal weighting vector at that time, and a weight vector obtained by subtracting said step vector from the estimate of the optimal weight vector; (ii) conducting marketing for fixed time intervals using the calculated prices; (iii) comparing profits obtained as a result; (iv) updating the estimate of the optimal weight vector at the time in question for each item is updated toward the price at which the higher profit was obtained; and (v) repeating the steps (i) to (iv); wherein the set price of each item is calculated as the inner product of the weight vector for each item and the attribute vector of the item.

Another object of the present invention is realized by a method of determining items to display in a web marketing system that performs electronic commerce on a network, the method comprising the steps of carrying out the above-described automatic pricing method; and selecting and displaying a fixed number of items that maximize an evaluation value which is higher amount of profit of profits that were obtained at two sales prices at each point in time and for each item, the two sales prices being adopted at preceding time point.

The present invention enables a web marketing system that automatically and rapidly carries out appropriate price setting in electronic commerce on a network such as the Internet in order to maximize profits during repeated marketing without setting appropriate prices in advance.

The above and other objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a block diagram showing the architecture of an automatic pricing and display item determination system according to a preferable embodiment of the present invention;

FIG. 2 shows the pseudo-code of StochPrice, which is a pricing method;

FIG. 3 shows the pseudo-code of FeaturePrice, which is a pricing method;

FIG. 4 shows the pseudo-code of VarietySelection, which is a display item determination method; and

FIG. 5 shows an example of a computer system for realizing the automatic pricing and display item determination system.

### DETAILED DESCRIPTION OF THE PREFERRED EMBODIMENTS

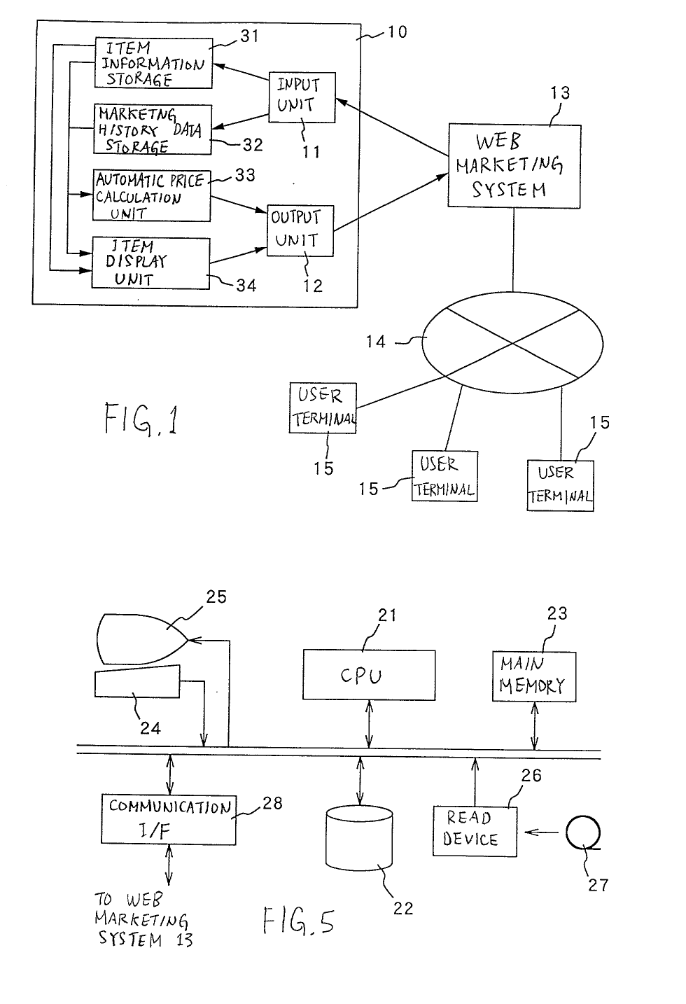

Automatic pricing and display item determination system 10 shown in FIG. 1 is used by connecting to web marketing system 13, which is connected to Internet 14, establishes an electronic commerce site, and carries out electronic commerce. Automatic pricing and display item determination system 10 is made up by: input unit 11, output unit 12, item information storage 31, marketing history data storage 32, automatic price calculation unit 33, and item display unit 34. User terminals 15 that are used by each customer are connected to Internet 14.

Input unit 11 communicates with web marketing system 13 and receives: various attribute information (item information) relating to items that are the object of marketing on this web marketing system 13; various attribute information relating to customers; and information relating to various sales conditions such as sales volume and price of each item for a fixed time period. The information relating to the various sales conditions is referred as marketing information. Information received in input unit 11 is stored in item information storage 31 and marketing history data storage 32, item information storage 31 specifically storing item information and marketing history data storage 32 storing the marketing information.

Based on marketing information, particularly marketing history data, stored in marketing history data storage 32 and the item information stored in item information storage 31, automatic price calculation unit 33 updates the price of each item and outputs the result as price information.

The manner of updating of the price of each item will be described in detail hereinbelow, but the price updating method is basically realized by marketing for fixed time intervals using a price that is one step higher and a price that is the same step lower than the optimal price estimate at that time, comparing the profits obtained as a result of this marketing, updating the optimal price estimate at that time in the direction of the price at which the higher profits were obtained, and then repeating this updating process.

Item display unit 34 determines the items that should be displayed in the web marketing system and the order of their display based on marketing information stored in marketing history data storage 32 and item information stored in item information storage 31, and outputs results as item display information. The actual method of selection of items that should be displayed and determination of the display order is described hereinbelow.

Output unit 12 communicates with web marketing system 13 and transmits price information obtained at automatic price calculation unit 33 and item display information obtained at item display unit 34 to web marketing system 13. Web marketing system 13 sets the prices of marketed items and sets the display order of items on the web page of web marketing system 13 based on the received price information and item display information.

Explanation next concerns automatic pricing in this automatic pricing and display item determination system, i.e., the calculation of item prices in automatic price calculation unit 33.

Explanation first concerns the items that serve as background. Although there are exceptions, the sales volume of an item is generally inversely proportional to its price. In this explanation, the number of items sold at price p is represented by S(p). Price elasticity varies according to the item, i.e., the sale of some items is sensitive to changes in price, while the sale of other items is less affected, and as a result, S(p) is considered to be unknown beforehand by the online marketing system. In online marketing, S(p) can be estimated by observing the number of items sold as price p is varied from hour to hour. As the simplest method, an item is marketed for fixed time intervals at a price that is a particular step size higher than the optimal price estimate at a particular time and a price that is the same step size lower than the optimal price estimate, the profits obtained as a result of this marketing are compared, and the optimal price estimate is updated in the direction of the price at which higher profits were obtained.

Profit per unit also changes according to price and sales volume. This function is generally difficult to determine due to the complex intertwining of factors such as reductions in cost resulting from mass production, but for individual items, it is considered possible to approximate this function as a function of price and sales volume. If the cost per unit is represented by C(p, N) as a function of price p and sales volume N, and the total profit at price p is represented by P(p), then:

P(p)=S(p)·(p—C(p,S(p)))

As a special case, the cost C of a product having digital content is not affected by sales volume, and the above formula can be simplified to:

P(p)=S(p)·p−C

It is an object of the automatic pricing method based on the present invention to estimate as rapidly as possible price p that maximizes P(p), and to automatically set this price. In other words, the value of p* such that:

$${P}^{*} = arg {max}_{p} P ( p )$$

is sought. It must be noted that the object here is to find p* and not necessarily to estimate P(p).

In the first automatic pricing method of the present invention, p* is independently estimated and the price set for each item. For the sake of simplification, a case is assumed in which unit cost does not change in accordance with price and sales volume. In other words, it is assumed that the function of total profit is:

P(p)=S(p)·p−C

In maximizing P(p), C can be ignored, and the formula can therefore be further simplified to:

P(p)=S(p)·p

In other words, P(p) can simply be taken as the sales. However, when determining the items that should be displayed in concert with this automatic pricing method (a case in which the method described hereinbelow of determining items to display is carried out), P(p) is generally taken as S(p)·p−C because comparisons must be made between the profits of different items.

Since legal constraints may apply to the price range, it is assumed that maximum possible price Pₘₐₓ and minimum possible price pₘᵢₙ are given. Since a common-sense price of a particular level is desired, input Pᵢₙᵢₜ is also given beforehand as the initial value of a price. The first automatic pricing method is repeated as follows based on this input information.

(1) The current value p of a price is set to initial price Pᵢₙᵢₜ.

(2) Online sales are carried out for fixed time intervals at both prices p+Δ and p−Δ for a step size Δ that is suitably determined as a decreasing function of the number of trials, and profit is calculated by the following formula according to the sales volumes (S(p+Δ) and S(p−Δ)) that are obtained in these time intervals. The value I^{-α} can be used as step size Δ, where 0<α<1 and I is the number of times (number of trials) in past marketing intervals. For example, Δ=I^{-⅓}.

P(p+Δ)=S(p+Δ)·(p+Δ)

P(p−Δ)=S(p−Δ)·(p−Δ)

the current price P is updated as follows:

$$p := p + \frac{A}{Δ} \frac{P ( p + Δ ) - P ( p - Δ )}{2 T}$$

where A is an update width constant that is determined as appropriate as a decreasing function of the number of trials (for example, A=1/I).

This value of A is clamped if p exceeds the maximum possible price or falls below the minimum possible price.

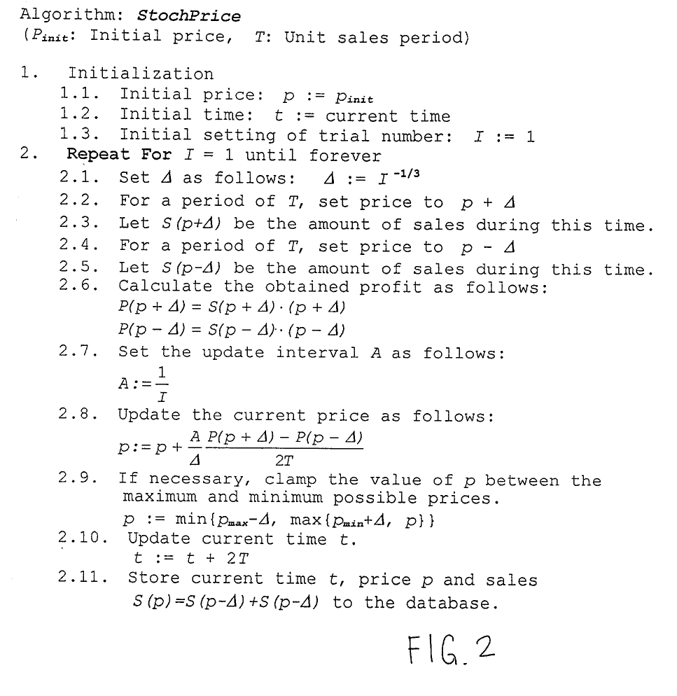

The above-described automatic pricing method is referred to as stochastic pricing. FIG. 2 shows the pseudo-code of procedure StochPrice for executing this automatic pricing method.

A method that uses item attributes is next explained as the second automatic pricing method.

A method for independent pricing of each item, for example, the above-described first pricing method, may take a considerable amount of time for the price of a new item to converge on the optimal price. In such a case, faster convergence upon a price that is close to the optimum through the use of information such as item attributes can be considered. Such an automatic pricing method is here proposed.

A binary attribute vector X of a particular item is given, and its components are written as, for example, xᵢ. These components may be purely item attributes such as item categories, or, if available, may be combined with user attributes such as age and gender. For example, a combined attribute x₁=y₁·y₂ may be constituted from the related attributes y₁=“cosmetics” and y₂=“female”. More accurately, for all values u₁, u₂, v₁, and v₂ that can be taken by x₁, x₂, y₁, and y₂, x₁=u₁, x₂=u₂, y₁=v₁, and y₂=v₂ are each defined as binary attributes; and in addition to these attributes, combined attributes such as (x₁=u₁)·(y₁=v₁) are used.

The basic idea of this second automatic pricing method is to assume that the optimal price of an item can be approximately represented as a linear function of the attributes of that item. In other words, there is a particular weight vector W having the same dimensions as an item attribute vector. The maximum value of the total profit function Pₓ(p) for any item when the item attribute of that item is X and when the price of X is p is approximately obtained at W·X.

$${p}_{x}^{*} = arg {max}_{p} P ( p ) = W \cdot X$$

It should be noted that it is here assumed that P*ₓ(p) can be linearly approximated, and this is definitely a weaker assumption than the assumption that the function Pₓ(p) itself can be approximated by some simple form (for example, linear). It can generally be predicted that Pₓ(p) is a complicated function, but it is not unnatural to assume that the optimal point can be (approximately) represented by a linear function of the attribute vector. As stated hereinabove, the object of the automatic pricing method is to find p*ₓ and not to estimate Pₓ(p), and using the above-described assumption therefore enables an efficient automatic pricing method.

The third automatic pricing method is a method that is similar in concept to the above-described second automatic pricing method for automatically pricing a single item but has as a special feature a search in a multidimensional parameter space (i.e., attribute space). The procedure of this method is as follows:

(1) Attribute vector X(i) is calculated for each of the object items based on the item attributes and the buyer attributes of the current user.

(2) The current value p(i) of the price for each item is set to an initial price W·X(i) using a current weighing vector W.

(3) Vector \vec{Δ}(i) of length Δ in a random direction is generated for each item i. Here, the “random direction” includes a direction generated by pseudo-random numbers. Δ is a step size that is appropriately determined as a decreasing function of the number of trials I. In this case as well, I is the number of times (number of trials) in past marketing intervals, and the value I^{-α} can be used as step size Δ, where 0<α<1. For example, Δ=I^{-⅓}.

(4) The current price of each item i is set as shown below using vector \vec{Δ}(i) that has been obtained in this way:

p(i):={W+\vec{Δ}(i)}·X(i)

Furthermore, if the above-described price p(i) exceeds a maximum price or falls below a minimum price, the above-described vector \vec{Δ}(i) for each item is amended by multiplying by a constant of the required minimum.

(5) The item is marketed for a fixed time interval at the above-described price p(i).

(6) The current price is set as shown below and the item is marketed for a fixed time interval.

p(i):={W−\vec{Δ}(i)}·X(i)

Furthermore, if the above-described price p(i) exceeds a maximum possible price or falls below a minimum possible price, the above-described vector \vec{Δ}(i) for each item is amended by multiplying by a constant of the required minimum.

The total profit for each case is calculated based on the number of sales S(W+\vec{Δ}(i)) and S(W−\vec{Δ}(i)) that are obtained as a result of the above-described sales for each item.

P(W+\vec{Δ}(i))=S(W+\vec{Δ}(i))·X(i)(W+\vec{Δ}(i))

P(W−\vec{Δ}(i))=S(W−\vec{Δ}(i))·X(i)(W−\vec{Δ}(i))

(8) The current weight vector W is updated once for each i as shown below using the value of \vec{Δ}(i):

$$W := W + \frac{A}{\vert \vec{Δ} ( i ) \vert} \frac{P ( W + \vec{Δ} ( i ) ) - P ( W - \vec{Δ} ( i ) )}{2 T}$$

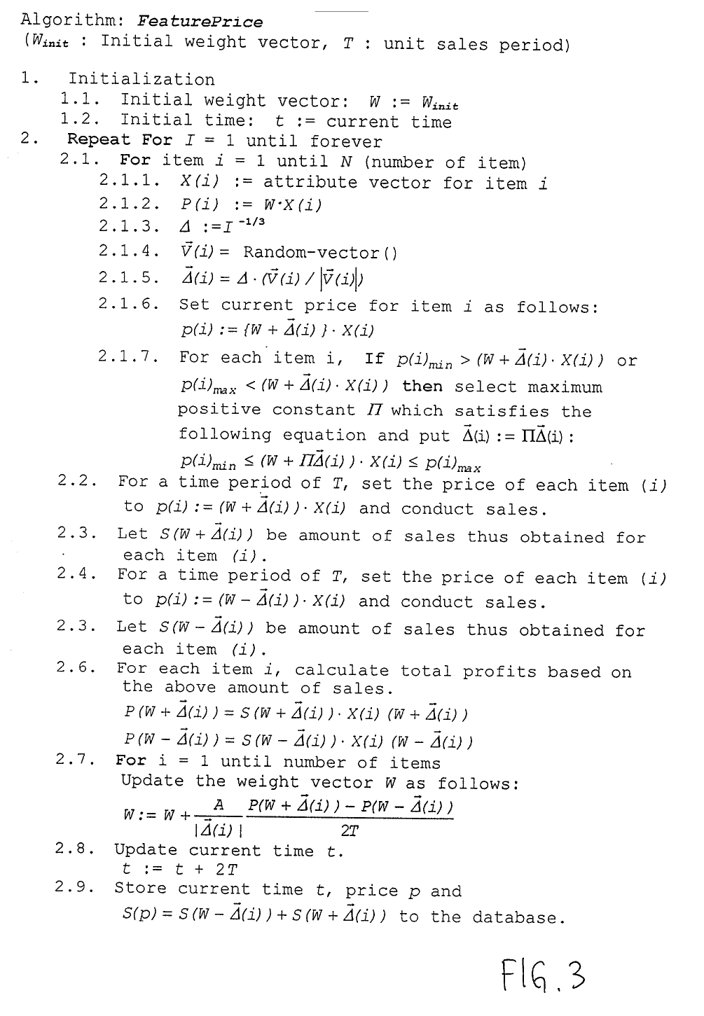

The above-described third automatic pricing method is also referred to as Feature-based Pricing. FIG. 3 shows pseudo-code of the procedure FeaturePrice for executing this third automatic pricing method.

A method of optimizing item display in addition to the above-described automatic pricing method is next explained. The display item determination method explained below is executed in item display unit 34.

Up to this point, automatic pricing methods have been described that have the object of maximizing total profit (or total sales) for an item. When a large number of items are handled on a single online marketing site, however, there is a limit to the number of items that can be “displayed” at one time on the online site. Even if all items can be displayed on the web site in theory, in actuality, it can be assumed that there will be great differences in the opportunities for a user to notice different items according to the selection of display order and display page. A strategy for maximizing total sales is therefore considered from two viewpoints: the selection of display items and the price of items.

Resolving the trade-off known as “Exploration-Exploitation trade-off” is one technical problem involved in this setting. The problem of automatic pricing that includes item display that is dealt with here takes on the following forms:

(1) If it is desired that the total sales in a current marketing interval be maximized, items should be displayed or selected in the order of higher estimated sales.

(2) If it is desired that the total accumulated sales when viewed over a long term be maximized, the optimal price for each item must be estimated rapidly, and a greater variety of items should be displayed or selected.

In actuality, it should be possible to obtain an optimal method of determining pricing and display items by adopting a strategy that is an intermediate of these reciprocal strategies. The following viewpoints were considered in this problem of automatic pricing that includes item display:

(1) The estimated profit at the current price of each item:

Since the object of online marketing by automatic pricing is the maximization of profit, it is desirable to display items having the highest possible estimated profit even in each trial.

(2) The variety of item attribute vectors:

In order to raise the accuracy of estimating the optimal price as a function of item attributes, it is desirable to raise the variety as the aggregation (set) of item attribute vectors of items that are displayed in each trial.

(3) The uncertainty of the estimation of the optimal price function:

In order to realize faster and more accurate estimation, it is desirable to obtain information for items for which the accuracy of estimated optimal price has been low in trials up to the present.

In more concrete terms, the following can be used as a measure (index) for measuring the above points:

(1) The profit in time interval 2T of the time each item is finally displayed:

PTotal(i,W)=P(W+\vec{Δ}(i))+P(W−\vec{Δ}(i))

(2) The sum of Hamming distance between display vectors:

$$H ( S ) = {\sum }_{u , v ∈ S} {\sum }_{i} \vert {x ( u )}_{i} - {x ( v )}_{i} \vert$$

where S is the aggregation of display items.

(3) The difference in profit between the first and second halves of the time each item is finally displayed:

PDiff(i,W)=|P(W+\vec{Δ}(i))+P(W−\vec{Δ}(i))|

The following two different item display strategies are obtained by combining these three measures:

(1) Uncertainty Selection:

From among display candidate items, a fixed number of items are selected for which the sum of the estimation uncertainty measure and the expected profit measure is a maximum.

PTotal(i,W)+PDiff(i,W)=P(W+\vec{Δ}(i))+P(W−\vec{Δ}(i))+|P(W+\vec{Δ}(i))+P(W−\vec{Δ}(i))|=2·max{P(W+\vec{Δ}(i)), P(W−\vec{Δ}(i))}

Essentially, this selection method is equivalent to ordering according to higher values in the two profit estimates of the last trial for each item. Expressed intuitively, this method is the display of items for which “profit may be high.”

(2) Variety Selection:

From among the display candidate items, a fixed number of items are selected for which the sum of the variety measure and expected profit measure is a maximum. In other words, an item aggregate S that is composed of a fixed number of items that maximize the following amount should be selected.

$${\sum }_{i ∈ S} {λ}_{1} PTotal ( i , W ) + {λ}_{2} H ( S )$$

where λ₁ and λ₂ are parameters for adjusting the contribution of the two measures.

These two methods are display item determination methods.

Regarding the Variety Selection, it is desirable to select S that maximizes the aggregation:

$${\sum }_{i ∈ S} {λ}_{1} PTotal ( i , W ) + {λ}_{2} H ( S )$$

As a result, seeking a strict optimal solution results an explosion in the number of combinations. Therefore, at the beginning, an initial solution (i.e., corresponding to λ=₁ and λ₂=0) is first found that maximizes:

$${\sum }_{i ∈ S} {λ}_{1} PTotal ( i , W )$$

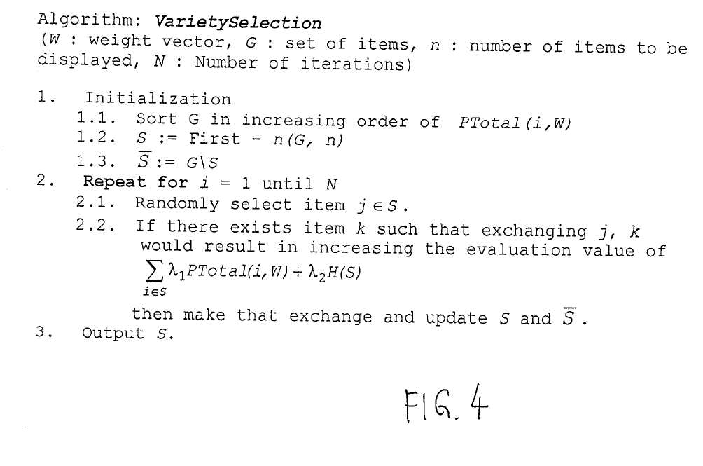

and from this solution, local optimal solutions are then found while repeating a successive exchanges to improve the above-described evaluation value. The details of this procedure (VarietySelection) are shown in FIG. 4 as pseudo-code. In addition, it is possible to use an annealing method in this procedure in which λ₂ is treated as a temperature.

The whole aspect of an automatic pricing method that incorporates the above-described method for selecting items that should be displayed is obtained by carrying out the procedures from line 2.2 to line 2.9 of the pseudo-code of StochPrice shown in FIG. 2 and from line 2.2 to line 2.7 of the pseudo-code of FeaturePrice shown in FIG. 3 for only the items that are selected by means of the above-described display item determination method, and not for all items. Variety Selection requires item attributes and therefore can be applied only for feature-based pricing (Feature Price). In cases in which the number of display items in a web page extends to a plurality of pages, the items can be sorted and the order of display determined by the above-described measures.

The above-described automatic pricing and determination of display items can be realized by reading a computer program for realizing these functions to a computer such as a server computer and then executing the program. A program for carrying out automatic pricing and determination of display items is read to a computer through the use of a recording medium such as magnetic tape or a CD-ROM. FIG. 5 is a block diagram showing the architecture of a computer that functions as the above-described automatic pricing and display item determination system by executing this type of program.

This computer is made up by: central processing unit (CPU) 21, hard disc device 22 for storing data or programs, main memory 23, input devices 24 such as a keyboard or mouse, display device 25 such as a CRT, read device 26 for reading recording medium 27 such as magnetic tape or a CD-ROM, and communication interface 28 for connecting to the web marketing system 13. Hard disc device 22, main memory 23, input device 24, display device 25, read device 26, and communication interface 28 are all connected to CPU 21.

This computer functions as an automatic pricing and display item determination system by: mounting recording medium 27, on which is stored a program for carrying out the automatic pricing and display item determination, in read device 26; reading the program from recording medium 27 and storing the program in hard disc device 22; and then executing the program that was stored on hard disc device 22 by means of CPU 21.

While preferred embodiments of the present invention have been described using specific terms, such description is for illustrative purposes only, and it is to be understood that changes and variations may be made without departing from the spirit or scope of the following claims.

What is claimed is:

1. An automatic pricing method for setting prices of items that are marketed in a web marketing system that performs electronic commerce on a network, comprising steps of:
at each point in time, carrying out marketing for fixed time intervals using a price that is one step size higher than, and a price that is one said step size lower than, an optimal price estimate at that time;
comparing profits obtained as a result of said marketing;
updating the optimal price estimate at time in question in a direction of price at which greater profit was obtained; and
repeating said marketing step, said comparison step, and said updating step.

2. An automatic pricing method according to claim 1 wherein said step size is determined by raising the number of past marketing time intervals to minus α power, where α is a positive number that is less than 1.

3. An automatic pricing method for setting prices of items that are marketed in a web marketing system that performs electronic commerce on a network, comprising the steps of:
(i) calculating, at each point in time, a price for each item by using both a weight vector obtained by adding a step vector that is generated randomly or pseudo-randomly to estimate of an optimal weighting vector at that time, and a weight vector obtained by subtracting said step vector from the estimate of said optimal weight vector;
(ii) conducting marketing for fixed time intervals using said calculated prices;
(iii) comparing profits obtained as a result;
(iv) updating the estimate of the optimal weight vector at the time in question for each item is updated toward price at which higher profit was obtained; and
(v) repeating the steps (i) to (iv);
wherein set price of each item is calculated as inner product of the weight vector for each item and an attribute vector of the item.

4. An automatic pricing method according to claim 3 wherein the size of said step vector is determined by raising the number of past marketing time intervals to a minus α power, where α is a positive number that is less than 1.

5. A display item determination method for selecting items that should be displayed from among a multiplicity of sales items in a web marketing system that performs electronic commerce on a network, comprising the steps of:
carrying out an automatic pricing method according to claim 3; and
selecting and displaying a fixed number of items that maximize an evaluation value which is higher amount of profit of profits that were obtained at two sales prices at each point in time and for each item, said two sales prices being adopted at preceding time point.

6. A display item determination method according to claim 5 wherein:
at each point in time, the expected profit for each item among a partial aggregate that is composed of a fixed number of elements among aggregate items of all sales objects is a sum of profit amounts of the two sales prices adopted at the preceding point in time; and
a partial aggregate that approximately maximizes a weighted sum of sums of expected profits for all items of said partial aggregate and an index that indicates variation between item attribute vectors of all items of said partial aggregate is selected and items that should be displayed are determined.

7. A method of determining items to display according to claim 6 wherein a sum of Hamming distances between pairs of all item attribute vectors of a partial aggregate is used as the index that indicates variation of the item attribute vectors of items in a partial aggregate.

8. An automatic pricing device for setting prices of items that are marketed in a web marketing system that performs electronic commerce on a network, comprising:
input means for receiving item information and marketing information that includes marketing history in the web marketing system from said web marketing system;
item information storage means for storing received item information;
marketing history data storage means for storing received marketing information;
automatic price calculation means that refers to item information stored in said item information storage means and marketing information stored in said marketing history data storage means, updates prices of said items, and outputs a result as price information; and
output means for transmitting said outputted price information to said web marketing system;
wherein said automatic price calculation means repeats, at each point in time, outputting of said price information such that marketing is performed for fixed time intervals at each of a price that is one step size higher than an optimal price estimate at that time and a price that is one said step size lower than said optimal price estimate; comparison of profits that are obtained as a result of said marketing; and updating of the optimal price estimate at that time in a direction of price at which higher profit was obtained.

9. An automatic pricing device for setting prices of items that are marketed in a web marketing system that performs electronic commerce on a network, comprising:
input means for receiving item information and marketing information that includes marketing history in the web marketing system from said web marketing system;
item information storage means for storing received item information;
marketing history data storage means for storing received marketing information;
automatic price calculation means that refers to item information stored in said item information storage means and marketing information stored in said marketing history data storage means, updates prices of said items, and outputs a result as price information; and
output means for transmitting said outputted price information to said web marketing system;
wherein said automatic price calculation means repeats calculation of set price of each item as inner product of a weight vector of each item and an attribute vector of the item; calculation, at each point in time, of a price for each item by using both a weight vector obtained by adding a step vector that is generated randomly or pseudo-randomly to estimate of an optimal weight vector at that time, and a weight vector obtained by subtracting said step vector from the estimate of said optimal weighting vector; outputting of said calculated price as said price information; comparison of profits that are obtained as a result; and updating of the estimate of the optimal weighting vector for each item at that time in a direction of price at which higher profit was obtained.

10. A device for automatic pricing and display item determination for setting prices of items that are marketed in a web marketing system that performs electronic commerce on a network and for determining items to display in said web marketing system; comprising:
input means for receiving item information and marketing information that includes marketing history in the web marketing system from said web marketing system;
item information storage means for storing received item information;
marketing history data storage means for storing received marketing information;
automatic price calculation means that refers to item information stored in said item information storage means and marketing information stored in said marketing history data storage means, updates prices of said items, and outputs a result as price information;
item display means that refers to item information stored in said item information storage means and marketing information stored in said marketing history data storage means, determines items to display in said web marketing system, and outputs a result as item display information; and
output means for transmitting said outputted price information and item display information to said web marketing system;
wherein said automatic price calculation means repeats calculation of set price of each item as inner product of a weight vector of each item and an attribute vector of the item; calculation, at each point in time, of a price for each item by using both a weight vector obtained by adding a step vector that is generated randomly or pseudo-randomly to estimate of an optimal weight vector at that time, and a weight vector obtained by subtracting said step vector from the estimate of said optimal weight vector; outputting of said calculated price as said price information; comparison of profits that are obtained as a result; and updating of the estimate of the optimal weight vector estimate for each item at that time in a direction of price at which higher profit was obtained; and
wherein said item display means, at each point in time, uses the higher of the profit amounts for two sales prices that were adopted at a previous point in time as an evaluation value for each item to select a fixed number of items that maximize said evaluation value and outputs a as item display information.

11. A recording medium that can be read by a computer and that stores a program for causing said computer to execute an automatic pricing method for setting prices of items that are marketed in a web marketing system that performs electronic commerce on a network, said method comprising the steps of:
at each point in time, carrying out marketing for fixed time intervals using a price that is one step size higher than, and a price that is one said step size lower than, an optimal price estimate at that time;
comparing profits obtained as a result of said marketing;
updating the optimal price estimate at time in question in a direction of price at which greater profit was obtained; and
repeating said marketing step, said comparison step, and said updating step.

12. A recording medium that can be read by a computer and that stores a program for causing said computer to execute an automatic pricing method for setting prices of items that are marketed in a web marketing system that performs electronic commerce on a network, said method comprising the steps of:
(i) calculating, at each point in time, a price for each item by using both a weight vector obtained by adding a step vector that is generated randomly or pseudo-randomly to estimate of an optimal weighting vector at that time, and a weight vector obtained by subtracting said step vector from the estimate of said optimal weight vector;
(ii) conducting marketing for fixed time intervals using said calculated prices;
(iii) comparing profits obtained as a result;
(iv) updating the estimate of the optimal weight vector at the time in question for each item is updated toward price at which higher profit was obtained; and
(v) repeating the steps (i) to (iv);
wherein set price of each item is calculated as inner product of the weight vector for each item and an attribute vector of the item.

13. A recording medium that can be read by a computer and that stores a program for causing said computer to execute an automatic pricing method and an display item selecting method;
said automatic pricing method comprising the steps of:
(i) calculating, at each point in time, a price for each item by using both a weight vector obtained by adding a step vector that is generated randomly or pseudo-randomly to estimate of an optimal weighting vector at that time, and a weight vector obtained by subtracting said step vector from the estimate of said optimal weight vector;
(ii) conducting marketing for fixed time intervals using said calculated prices;
(iii) comparing profits obtained as a result;
(iv) updating the estimate of the optimal weight vector at the time in question for each item is updated toward price at which higher profit was obtained; and
(v) repeating the steps (i) to (iv);
wherein set price of each item is calculated as inner product of the weight vector for each item and an attribute vector of the item;
said display item selecting method comprising the step of:
selecting and displaying a fixed number of items that maximize an evaluation value which is higher amount of profit of profits that were obtained at two sales prices at each point in time and for each item, said two sales prices being adopted at preceding time point.
